(19) United States
(12) Patent Application Publication
(10) Pub. No.: US 2026/0276164 A1
(43) Pub. Date: Sep. 17, 2026

(54) VEHICLE HEADLIGHT

(71) Applicant: ICHIKOH INDUSTRIES, LTD., Isehara-shi (JP)

(72) Inventor: Kazunori IWASAKI, Kanagawa (JP)

(73) Assignee: ICHIKOH INDUSTRIES, LTD., Isehara-shi (JP)

(21) Appl. No.: 19/472,875

(22) PCT Filed: Apr. 11, 2024
(86) PCT No.: PCT/JP2024/014738

§ 371 Date: Oct. 6, 2025

(30) Foreign Application Priority Data
Apr. 11, 2023 (JP) 2023-064343

(51) Int. Cl. F21S 41/275; F21S 41/143; F21S 41/151; F21S 41/255; F21S 41/663; F21W 102/135

(52) U.S. Cl. CPC F21S 41/275; F21S 41/143; F21S 41/151; F21S 41/255; F21S 41/663; F21W 2102/135

(57) ABSTRACT

A vehicle headlight includes: a plurality of light sources disposed in a left-right direction; a light-source-side lens disposed in front of the light sources and emitting light forward; and a projection lens disposed in front of the light-source-side lens and emitting, in front of a vehicle, the light emitted from the light-source-side lens. The light-source-side lens includes an incident surface through which light from the light sources enters. The incident surface includes at least one groove portion disposed at a position offset from an optical axis of the projection lens in the left-right direction and extending in an up-down direction. The groove portion includes an inclined portion that refracts the light from the light sources toward a side closer to the optical axis.

### TECHNICAL FIELD

The present invention relates to a vehicle headlight.

### BACKGROUND ART

A vehicle headlight has been known that individually controls the respective lighting states of a plurality of light sources, such as LEDs, to form an ADB light distribution pattern in front of the vehicle.

### PRIOR ART LITERATURE

### Patent Literature

Patent Literature 1: JP 2018-98105 A

### SUMMARY OF INVENTION

### Problems to be Solved by the Invention

According to such a vehicle headlight as described in Patent Literature 1, in a case where beams of light from a plurality of light sources enter a projection lens through positions away in the left-right direction from the center of the projection lens, there is a possibility that an illumination pattern emitted through the projection lens will become blurred.

The present invention has been made in view of the above, and has an object to provide a vehicle headlight enabling inhibition of an illumination pattern from being blurred.

### Solution to Problems

A vehicle headlight according to the present invention includes: a plurality of light sources disposed in a left-right direction; a light-source-side lens disposed in front of the light sources and emitting light forward; and a projection lens disposed in front of the light-source-side lens and emitting, in front of a vehicle, the light emitted from the light-source-side lens. The light-source-side lens includes an incident surface through which light from the light sources enters. The incident surface includes at least one groove portion disposed at a position offset from an optical axis of the projection lens in the left-right direction and extending in an up-down direction. The groove portion includes an inclined portion that refracts the light from the light sources toward a side closer to the optical axis.

### Effects of the Invention

According to the present invention, provided is a vehicle headlight capable of inhibiting blurring of an illumination pattern.

### BRIEF DESCRIPTION OF DRAWINGS

FIG. 1 is a perspective view illustrating an exemplary vehicle headlight according to the present embodiment.

FIG. 2 illustrates an exemplary light-source-side lens.

FIG. 3 illustrates the exemplary light-source-side lens.

FIG. 4 illustrates the exemplary light-source-side lens.

FIG. 5 illustrates the exemplary light-source-side lens.

FIG. 6 illustrates the exemplary light-source-side lens.

FIG. 7 illustrates the exemplary light-source-side lens.

FIG. 8 illustrates an exemplary operation of the vehicle headlight.

FIG. 9 illustrates an exemplary operation of the vehicle headlight.

FIG. 10 illustrates an exemplary operation of the vehicle headlight.

FIG. 11 illustrates an exemplary ADB pattern produces by the vehicle headlight.

### EMBODIMENTS FOR CARRYING OUT THE INVENTION

A vehicle headlight according to an embodiment of the present invention will be described below based on the drawings. The present invention is not limited to the embodiment. The constituent elements in the following embodiment include constituent elements easily replaceable by those skilled in the art and substantially the same constituent elements.

In the following description, front-rear, up-down, and left-right directions refer to directions when a vehicle headlight is mounted on a vehicle, namely, directions when viewed from the driver's seat in the travel direction of the vehicle. In the present embodiment, the up-down direction is parallel to the vertical direction, and the left-right direction is the horizontal direction. In the present embodiment, the front and rear directions are, for example, directions in a state where the vehicle headlight is mounted on the vehicle (vehicle mounted state). For example, when mounted on a front portion (front) of the vehicle, the front is the front direction (front side), and the rear is the rear direction (rear side).

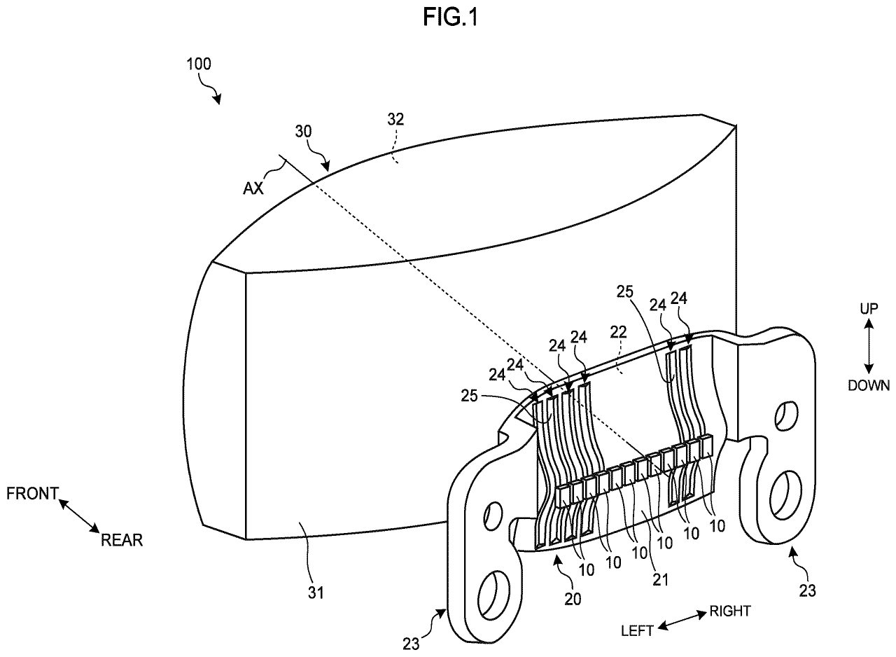

FIG. 1 is a perspective view illustrating an example of a vehicle headlight 100 according to the present embodiment. As illustrated in FIG. 1, the vehicle headlight 100 includes a plurality of light sources 10, a light-source-side lens 20, and a projection lens 30. The vehicle headlight 100 forms an ADB light distribution pattern ahead of a vehicle by individually controlling the turn on and off of the light sources 10. The vehicle headlight 100 is disposed on each of the left side and right side of the front of the vehicle. In the present embodiment, as an example, the vehicle headlight 100 disposed on the right side of the vehicle will be described. The vehicle headlight disposed on the left side of the vehicle has configuration symmetrical to, for example, the vehicle headlight 100 according to the present embodiment.

The light sources 10 are, for example, semiconductor elements, such as light emitting diodes (LEDS). The light sources 10 are disposed side by side in the left-right direction. In the present embodiment, for example, twelve light sources 10 are arrayed in the left-right direction. The pitch of the light sources 10 in the left-right direction is not particularly limited, and may be, for example, all the same, all different, or at least two of the pitches may be the same.

One of the light sources 10 is disposed on the optical axis AX of the projection lens 30. The interval between adjacent light sources 10 in the left-right direction may vary depending on the light source 10. The number of light sources 10 disposed on the left side of the optical axis AX is larger than the number of light sources 10 disposed on the right side of the optical axis AX. Light emitting surfaces 11 of the light sources 10 are directed toward the front of the vehicle. The light sources 10 are mounted on a substrate, not illustrated, on which wiring and the like are formed. The substrate is supported by a support member, such as a heat sink.

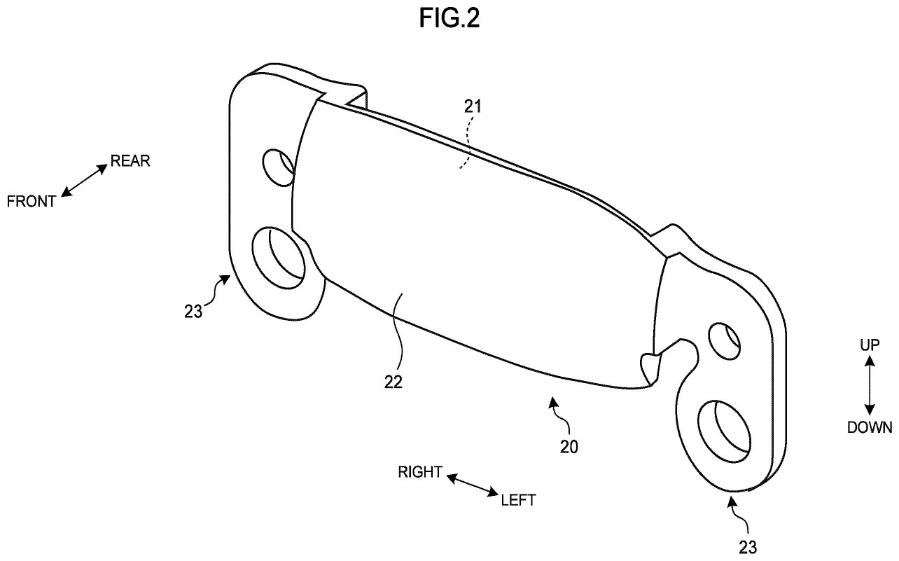

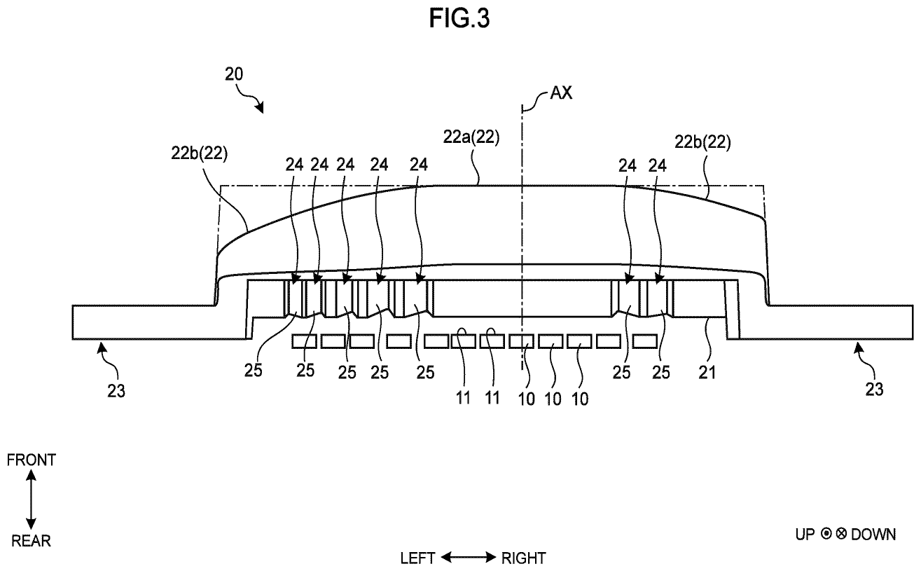

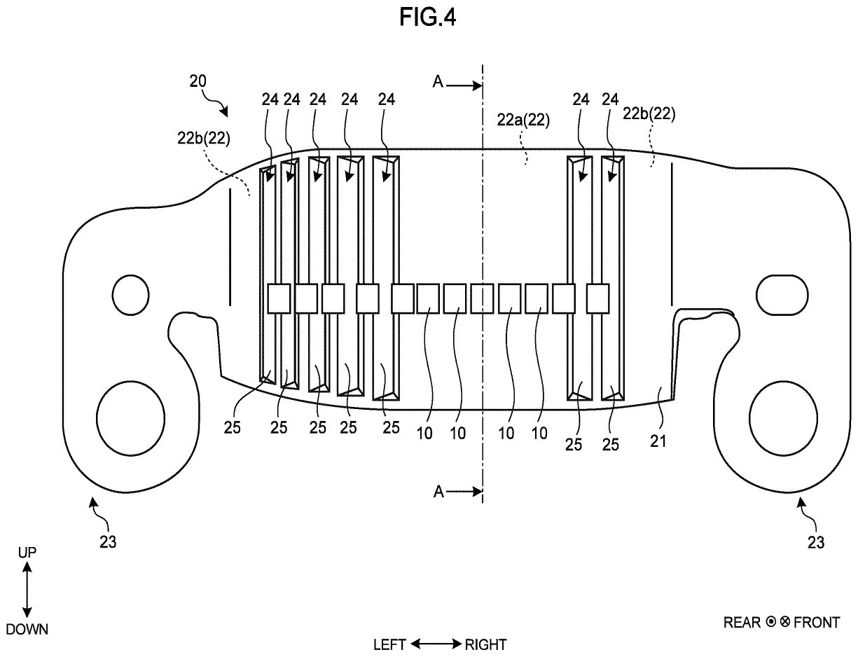

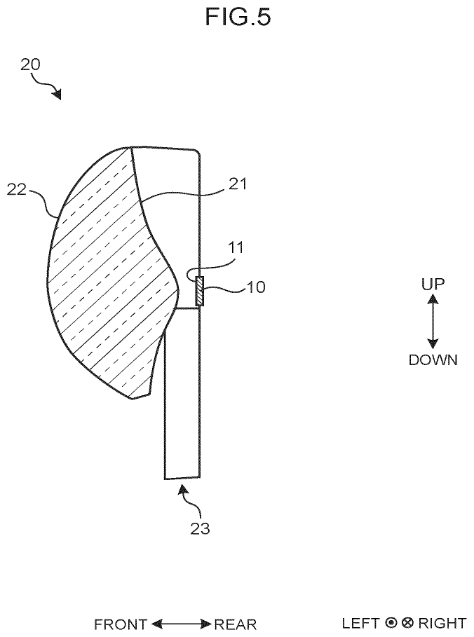

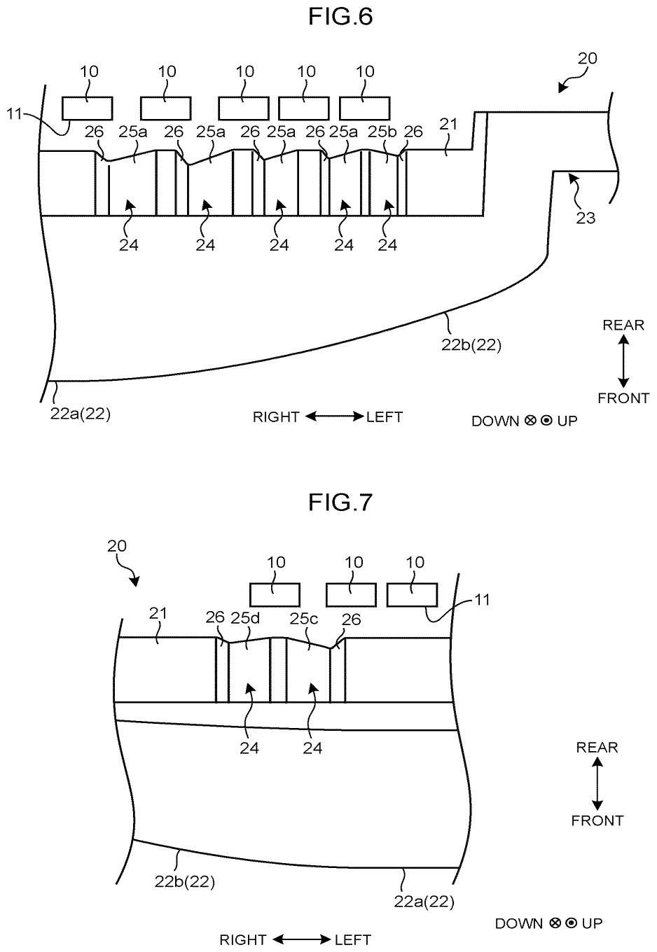

The light-source-side lens 20 is disposed in front of the light sources 10. FIGS. 2 to 7 illustrate an example of the light-source-side lens 20. FIG. 2 is a perspective front view. FIG. 3 is a top view. FIG. 4 is a rear view. FIG. 5 is a sectional view taken along line A-A of FIG. 4. FIG. 6 is an enlarged view illustrating a configuration on the left side with respect to the optical axis AX of the projection lens 30 in FIG. 3. FIG. 7 is an enlarged view illustrating a configuration on the right side with respect to the optical axis AX of the projection lens 30 in FIG. 3. As illustrated in FIGS. 1 to 7, the light-source-side lens 20 has an incident surface 21 and an exit surface 22.

Light from the light sources 10 is incident on the incident surface 21. In longitudinal sectional view (refer to FIG. 5), the incident surface 21 is curved such that its central portion in the up-down direction protrudes toward the light sources 10.

The input face 21 includes a groove portion 24. The groove portion 24 is disposed at a position offset in the left-right direction from the optical axis AX of the projection lens 30. In the present embodiment, a plurality of groove portions 24 is disposed. For example, four groove portions 24 are disposed on a side (left side) closer to the center of the vehicle, and two groove portions 24 are disposed on a side (right side) closer to the outside of the vehicle in the left-right direction with respect to the optical axis AX. That is, the number of groove portions 24 closer to the center of the vehicle in the left-right direction with respect to the optical axis AX is larger than the number of groove portions 24 closer to the outside of the vehicle in the left-right direction with respect to the optical axis AX. In the present embodiment, the vehicular front lighting 100 is configured to be disposed on the right side of the vehicle, and the number of light sources 10 disposed on the left side, which is closer to the center of the vehicle with respect to the optical axis AX, is larger than the number of light sources 10 disposed on the right side, which is closer to the outside of the vehicle with respect to the optical axis AX. Therefore, in accordance with the configuration, the number of groove portions 24 on the left side of the optical axis AX is larger than the number of groove portions 24 on the right side of the optical axis AX. In this way, the number of groove portions 24 disposed on the left side of the optical axis AX and the number of groove portions 24 disposed on the right side of the optical axis AX can be configured to be different from each other.

The number of groove portions 24 may be one. In the present embodiment, the groove portions 24 are disposed on the left and right sides of the optical axis AX, but the present invention is not limited to this configuration. For example, the groove portions 24 may be disposed only on one of the left and right sides of the optical axis AX. For example, the groove portion 24 does not have to be disposed on the side (right side) closer to the outside of the vehicle in the left-to-right direction with respect to the optical axis AX.

The groove portions 24 are spaced apart in the left-right direction. The groove portions 24 extend in the up-down direction. The width of each of the groove portions 24 is substantially uniform in the up-down direction. The groove portions 24 may have different widths in the left-right direction.

Each of the groove portions 24 is formed in a V-shape when viewed from above (refer to FIG. 3) such that its depth gradually increases from both sides in the left-right direction toward the center. Each of the groove portions 24 includes an inclined portion 25 and a connection portion 26. The inclined portion 25 and the connection portion 26 are, for example, each linear in cross section and are each provided at an angle with respect to a plane orthogonal to the optical axis AX. In each groove portion 24, the inclined portion 25 is provided on one side in the left-right direction, and the connection portion 26 is provided on the other side in the left-right direction.

The inclined portions 25 are each formed in a shape that refracts the light from the light sources 10 toward a side closer to the optical axis AX. For example, among the groove portions 24 disposed on the left side of the optical axis AX, the groove portions 24 other than the groove portion 24 disposed at the left end in the left-right direction are formed such that their inclined portions 25 are inclined frontward toward the right. The groove portion 24 disposed at the left end in the left-right direction is formed such that its inclined portion 25 is inclined forward toward the left. Hereinafter, when distinguishing between the inclined portions 25 of the groove portions 24 disposed on the left side of the optical axis AX, the inclined portion 25 of the groove portion 24 disposed at the left end in the left-right direction will be referred to as an inclined portion 25b, and the inclined portions 25 of the other groove portions 24 will be referred to as inclined portions 25a (for example, refer to FIG. 6).

The groove portions 24 disposed on the right side of the optical axis AX are formed such that their inclined portions 25 are frontward toward the left. However, the groove portion 24 disposed at the right end in the left-right direction is formed such that its inclined portion 25 is inclined frontward toward the right. Hereinafter, when distinguishing between the inclined portions 25 of the groove portions 24 disposed on the right side of the optical axis AX, the inclined portion 25 of the groove portion 24 disposed at the right end in the left-right direction will be referred to as an inclined portion 25d, and the inclined portion 25 of the other groove portion 24 will be referred to as an inclined portion 25c (for example, refer to FIG. 7).

In one groove portion 24, the inclined portion 25 and the connection portion 26 each have a rounded boundary with the incident surface 21. The boundary between the inclined portion 25 and the connection portion 26 has a rounded shape.

When viewed in an optical-axis direction along the optical axis AX, each of the groove portions 24 is disposed such that at least a part of the portion of the incident surface 21 facing the corresponding light source 10 is left. In other words, when viewed in the optical-axis direction, at least a part of each of the light sources 10 is disposed at a position that faces the incident surface 21 between adjacent groove portions 24 in the left-right direction. When viewed in the optical-axis direction, each of the groove portions 24 is disposed such that its inclined portion 25 is located between the light sources 10 that are adjacent in the left-right direction.

The light incident on the incident surface 21 exits through the exit surface 22. As illustrated in FIG. 3 and other figures, the exit surface 22 includes a central portion 22a disposed at its center in the left-right direction and curved portions 22b disposed on both sides in the left-right direction. The optical axis AX passes through the central portion 22a. For example, the central portion 22a is cylindrical, and its front end is linear when viewed from above.

The curved portions 22b are formed so as to curve toward the rear side from the central portion 22a to both ends in the left-right direction. For example, when viewed in the optical-axis direction along the optical axis AX, the groove portions 24 can be disposed in portions corresponding to the curved portions 22b. Furthermore, in longitudinal sectional view (refer to FIG. 5), the exit surface 22 is formed so as to curve toward the rear side from its central portion in the up-down direction to both the upper and lower sides. The entire exit surface 22 has a shape in which the central portion 22a and each of the left and right curved portions 22b are stepless, with continuous tangents and continuous curvature.

In the present embodiment, the light sources 10 on the left side of the optical axis AX of the projection lens 30 are provided over a wider range in the left-right direction than the light sources 10 on the right side are. Thus, in accordance with the arrangement of the light sources 10, the right curved portion 22b has a shape that is bilaterally symmetrical to the left curved portion 22b, with a part of the right end cut off. Therefore, the left curved portion 22b is provided over a wider range than the right curved portion 22b is. Note that the left and right curved portions 22b are curved from the central portion 22a to the left and right in the left-right direction with equal curvature.

The light-source-side lens 20 is provided with attachment portions 23. The attachment portions 23 are disposed on both sides in the left-right direction of the light-source-side lens 20. The attachment portions 23 are each attached via a fastener, such as a screw, not illustrated.

The projection lens 30 is disposed in front of the light-source-side lens 20. The projection lens 30 is held, for example, by a holder, not illustrated. The projection lens 30 has an incident surface 31 and an exit surface 32. Light from the light-source-side lens 20 is incident on the indent surface. The exit surface 32 emits light incident on the incident surface 31 in a direction ahead of the vehicle to form an ADB pattern.

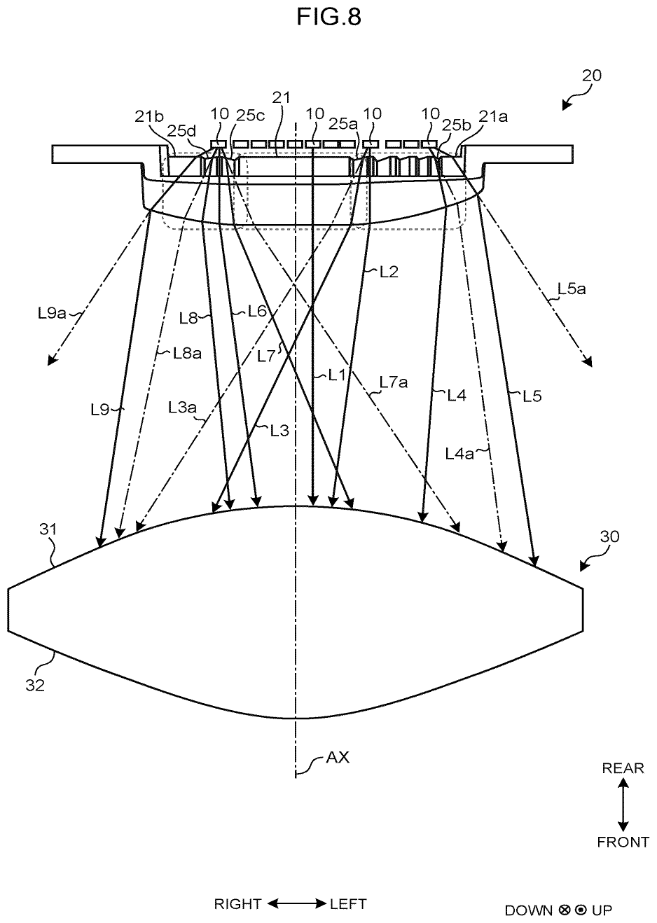

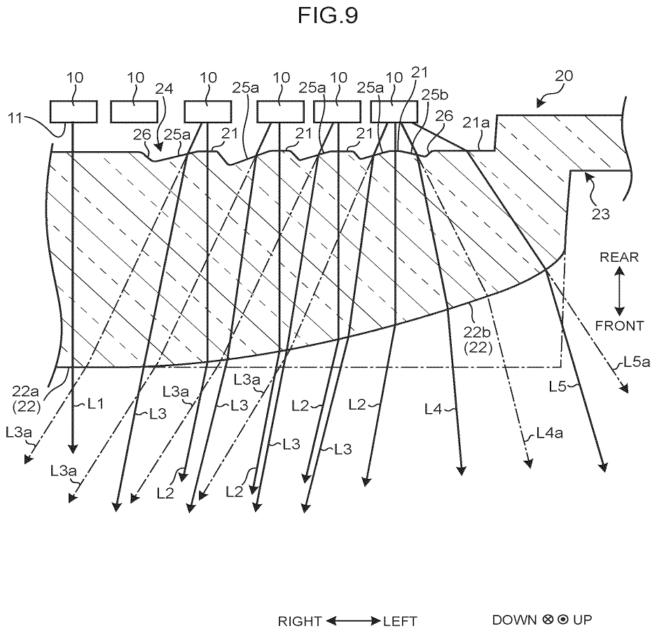

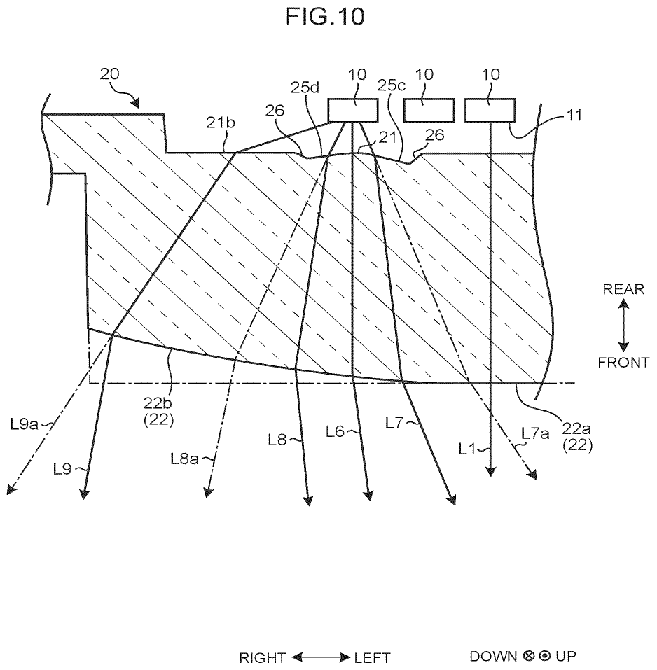

Next, the operation of the vehicle headlight 100 configured as described above will be described. FIGS. 8 to 10 illustrate an exemplary operation of the vehicle headlight 100. FIGS. 9 and 10 are each an enlarged view of part of FIG. 8. Note that FIGS. 9 and 10 each illustrate a configuration along a cross section parallel to a horizontal plane.

When the light sources 10 of the vehicle headlight 100 are turned on, light is emitted from the light emitting surfaces 11. As illustrated in FIG. 8, light L1 from a light source 10, among the plurality of light sources 10, disposed in a range corresponding to the central portion 22a of the exit surface 22 when viewed in the optical-axis direction along the optical axis AX, enters the light-source-side lens 20 through the incident surface 21 and then is emitted forward through the exit surface 22. The light L1 enters the projection lens 30 through the incident surface 31 and then is emitted through the exit surface 32 to form at least a part of an ADB pattern ahead the vehicle.

As illustrated in FIG. 8, light L2 and light L3 are parts of light from a light source 1, among the plurality of light sources 10, disposed in a range corresponding to the left curved portion 22b of the exit surface 22. The light L2 enters through the incident surface 21 between groove portions 24 arrayed in the left-right direction, and the light L3 enters through the inclined portion 25a of one of the groove portions 24. Furthermore, for example, light L4 and light L5 are parts of light emitted from the light source 10 disposed at the left end. The light F4 enters through the inclined portion 25b of the groove portion 24, and the light L5 enters through the incident surface 21 located on the left side of the groove portion 24 at the left end (hereinafter, referred to as the left end portion 21a of the incident surface 21).

For example, the light L2, which has entered through the incident surface 21, is emitted through the central portion 22a of the exit surface 22 and then reaches the incident surface 31 of the projection lens 30.

When entering through the inclined portion 25a of the groove portion 24, the light L3 is refracted by the inclined surface 25a toward the side closer to the optical axis AX and then is emitted through the central portion 22a or the corresponding curved portion 22b of the exit surface 22. The light L3 reaches the incident surface 31 of the projection lens 30 on a side closer to the optical axis AX than light L3a (indicated with dot-dashed lines in FIGS. 8 and 9) for a case in which the inclined portion 25a is not provided.

When entering through the inclined portion 25b of the groove portion 24, the light L4 is refracted by the inclined portion 25b toward the side closer to the optical axis AX and then is emitted through the corresponding curved portion 22b of the exit surface 22. The light L4 is refracted so that an angle formed with the optical axis AX is smaller than that of light L4a (indicated with dot-dashed lines in FIGS. 8 and 9) for a case in which the inclined portion 25b is not provided, and then reaches the incident surface 31 of the projection lens 30 on a side closer to the optical axis AX.

The light L5 incident on the left end portion 21a of the incident surface 21 is emitted through the corresponding curved portion 22b of the exit surface 22 in a state of being refracted toward the side closer to the optical axis AX, and then reaches the incident surface 31 of the projection lens 30. If no curved portion 22b is formed, light L5a (indicated with dot-dashed lines in FIGS. 8 and 9) incident on the incident surface 21 at the left end is emitted through a side portion of the light-source-side lens 20 and thus does not reach the projection lens 30. In contrast to this, by forming the corresponding curved portion 22b, the light L5, which has entered through the incident surface 21 at the left end, is refracted toward the side closer to the optical axis AX due to the corresponding curved portion 22b of the exit surface 22 and is emitted to reach the incident surface 31 of the projection lens 30. This increases the usage efficiency of light.

As illustrated in FIGS. 8 and 9, light L6 is a part of light emitted from a light source 10, among the plurality of light sources 10, disposed in a range corresponding to the right curved portion 22b of the exit surface 22. The light L6 enters through the incident surface 21 between groove portions 24 arrayed in the left-right direction. Light L7, which is a part of light, enters through the inclined portion 25c of one of the groove portions 24. For example, light L8 and light L9 are parts of light emitted from the light source 10 disposed at the left end. The light L8 enters through the inclined portion 25d of the groove portion 24, and the light L9 enters through the incident surface 21 located to the right of the groove portion 24 at the right end (hereinafter, referred to as the right end portion 21b of the incident surface 21).

For example, the light L6, which has entered through the incident surface 21, is emitted through the central portion 22a of the exit surface 22 and then reaches the incident surface 31 of the projection lens 30.

When entering through the inclined portion 25b of the groove portion 24, the light L7 is refracted by the inclined portion 25c toward the side closer to the optical axis AX and then is emitted through the central portion 22a or the corresponding curved portion 22b of the exit surface 22. The light L7 reaches the incident surface 31 of the projection lens 30 on a side closer to the optical axis AX than light L7a (indicated with dot-dashed lines in FIGS. 8 and 10) for a case in which the inclined portion 25c is not provided.

When entering through the inclined portion 25d of the groove portion 24, the light L8 is refracted by the inclined portion 25d toward the side closer to the optical axis AX and then is emitted through the corresponding curved portion 22b of the exit surface 22. The light L8 is refracted so that an angle formed with the optical axis AX is smaller than that of light L8a (indicated with dot-dashed lines in FIGS. 8 and 10) for a case in which the inclined portion 25d is not provided, and then reaches the incident surface 31 of the projection lens 30 on a side closer to the optical axis.

The light L9, which has entered through the right end portion 21b of the incident surface 21, is emitted through the corresponding curved portion 22b of the exit surface 22 in a state being refracted toward the side closer to the optical axis AX, and then reaches the incident surface 31 of the projection lens 30. If no curved portion 22b is provided, light L9a (indicated with dot-dashed lines in FIGS. 8 and 10) incident on the incident surface 21 at the right end is emitted through a side portion of the light-source-side lens 20 and thus does not reach the projection lens 30. In contrast to this, by forming the formation of the corresponding curved portion 22b, the light L9, which has entered through the incident surface 21 at the right end, is refracted toward the side closer to the optical axis AX by the corresponding curved portion 22b of the exit surface 22 and is emitted to reach the incident surface 31 of the projection lens 30. This increases the usage efficiency of light.

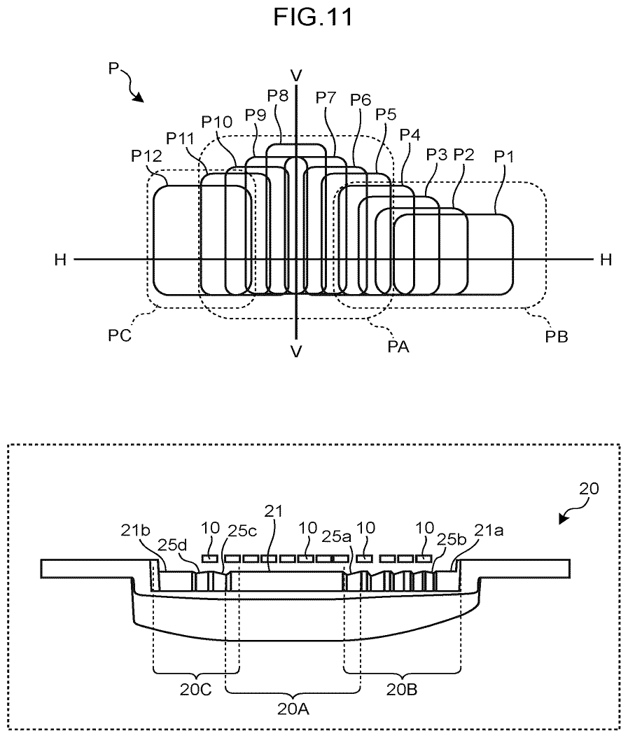

FIG. 11 illustrates an exemplary ADB pattern produced by the vehicle headlight. In FIG. 11, line H-H represents a horizontal line and line V-V represents a line parallel to the vertical direction (hereinafter, referred to as a vertical line). The light L1 to light L9 that reach the incident surface 31 as described above enter through the incident surface 31 and then exit through the exit surface 32 to form an ADB pattern P in front of the vehicle. As illustrated in FIG. 11, the ADB pattern P includes patterns P1 to P12 respectively corresponding to the light sources 10 and aligned with partial overlapping in the left-right direction. A central region PA in the ADB pattern P is formed by a central region 20A of the light-source-side lens 20 (refer to FIG. 11). A left region PB in the ADB pattern P is formed by a left region 20B of the light-source-side lens 20 (refer to FIG. 11). A right region PC in the ADB pattern P is formed due to a right region 20C of the light-source-side lens 20 (refer to FIG. 11).

As described above, the vehicle headlight 100 according to the present embodiment includes: a plurality of light sources 10 disposed in a left-right direction; a light-source-side lens 20 disposed in front of the light sources 10 and emitting light forward; and a projection lens 30 disposed in front of the light-source-side lens 20 and emitting, in front of the vehicle, the light emitted from the light-source-side lens 20. The light-source-side lens 20 includes an incident surface 21 through which light from the light sources 10 enters. The incident surface 21 includes at least one groove portion 24 disposed at a position offset from the optical axis AX of the projection lens 30 in the left-right direction and extending in the up-down direction. The groove portion 24 includes an inclined portion 25 that refracts the light from the sources 10 toward the side closer to the optical axis AX.

According to this configuration, when the light from the light sources 10 is incident on the incident surface 21 of the light-source-side lens 20 at a position that is separated in the left-right direction from the optical axis AX of the projection lens 30, part of the light is refracted toward the side closer to the optical axis AX by the inclined portion 25 of the groove portion 24. Thus, compared to the configuration in which the groove portion 24 and the inclined portion 25 are not provided, the light emitted from the light-source-side lens 20 can reach the projection lens 30 on the side closer to the optical axis AX. In this way, an illumination pattern can be formed using the neighborhood of the optical axis AX in the left-right direction of the projection lens 30, so that the illumination pattern can be formed while minimizing the use of the outer peripheral portion, which is greatly affected by aberration. This makes it possible to inhibit blurring of the illumination pattern. For example, in a case where the curvature of the exit surface 32 of the projection lens 30 is reduced, an exit surface 32 small in curvature, the use of the outer peripheral portion, which is more affected by aberration, can be reduced, thereby inhibiting blurring in an illumination pattern formed at positions farther in the left-right direction from the center.

In the vehicle headlight 100 according to the present embodiment, when viewed in an optical-axis direction along the optical axis AX, the groove portion 24 is disposed such that at least a part of a portion of the incident surface 21 facing the corresponding light source 10 is left. According to this configuration, by disposing the incident surface 21 in at least a part of the portion facing the corresponding light source 10, light traveling forward from the light sources 10 and incident on the incident surface 21 can be made to reach a predetermined portion of the incident surface 31 of the projection lens 30. This makes it possible to reliably inhibit blurring of the illumination pattern.

In the vehicle headlight 100 according to the present embodiment, when viewed in the optical-axis direction along the optical axis AX, the groove portion 24 is disposed such that the inclined portion 25 is located between the light sources 10 that are adjacent in the left-right direction. According to this e configuration, the light emitted from the light sources 10 in left oblique and right oblique directions can be reliably refracted toward the side closer to the optical axis AX by the inclined portion 25.

In the vehicle headlight 100 according to the present embodiment, a plurality of the groove portions 24 is spaced apart in the left-right direction. According to this configuration, the light is refracted by the groove portions 24, and thus the light emitted from the light-source-side lens 20 can reach the projection lens 30 on a side closer to the optical axis AX.

In the vehicle headlight 100 according to the present embodiment, the groove portions 24 are disposed on a left side and a right side of the optical axis AX. According to this configuration, the light that reaches both the left and right sides of the optical axis AX of the incident surface 21 is refracted by the groove portions 24, thereby enabling the light emitted from the light-source-side lens 20 to more reliably reach the projection lens 30 on a side closer to the optical axis AX.

In the vehicle headlight 100 according to the present embodiment, the groove portions 24 are disposed closer to an outside of the vehicle in the left-right direction with respect to the optical axis AX. According to this configuration, the light that reaches the incident surface 21 closer to the outside of the vehicle in the left-right direction with respect to the optical axis AX is refracted by the groove portions 24, thereby enabling the light emitted from the light-source-side lens 20 to more reliably reach the projection lens 30 on a side closer to the optical axis AX.

In the vehicle headlight 100 according to the present embodiment, the number of groove portions 24 disposed on the left side of the optical axis AX is different from the number of groove portions 24 disposed on the right side of the optical axis AX. According to this configuration, the number of groove portions 24 disposed on the left side of the optical axis AX and the number of groove portions 24 disposed on the right side of the optical axis AX can be flexibly set depending on conditions, for example, depending on whether the vehicle headlight 100 is disposed on the left or right side of the vehicle.

In the vehicle headlight 100 according to the present embodiment, the light-source-side lens 20 has an exit surface 22 through which the light incident on the incident surface 21 exits, and the exit surface 22 includes a central portion 22a through which the optical axis AX passes and a curved portion 22b that curves to a rear side from the central portion 22a to both ends in the left-right direction of the exit surface 22. According to this configuration, the light that reaches each side in the left-right direction of the exit surface 22 can be emitted in a state of being refracted toward a side closer to the optical axis AX by the corresponding curved portion 22b. Thus, compared to a configuration in which no curved portion 22b is provided, more light that reaches the exit surface 22 can reach the projection lens 30. This makes it possible to improve the usage efficiency of light.

In the vehicle headlight 100 according to the present embodiment, the groove portion 24 is disposed in a portion overlapping the curved portion 22b when viewed in an optical-axis direction along the optical axis AX.

According to this configuration, the light that is refracted by the groove portion 24 on the incident surface side and then reaches the curved portion 22b can be bent toward the side closer to the optical axis AX by the curved portion 22b, thereby enabling the light to more reliably reach the neighborhood of the optical axis AX of the projection lens 30.

The technical scope of the present invention is not limited to the above-described embodiment and thus appropriate modifications can be made without departing from the sprit of the present invention.

### EXPLANATION OF REFERENCE NUMBERS

AX OPTICAL AXIS
10 LIGHT SOURCE
11 LIGHT EMITTING SURFACE
20 LIGHT-SOURCE-SIDE LENS
21, 31 INCIDENT SURFACE
21a LEFT END PORTION
21b RIGHT END PORTION
22, 32 EXIT SURFACE
22a CENTRAL PORTION
22b CURVED PORTION
23 ATTACHMENT PORTION
24 GROOVE
25, 25a, 25b, 25c, 25d INCLINED PORTION
26 CONNECTION PORTION
30 PROJECTION LENS
100 VEHICLE HEADLIGHT

1. A vehicle headlight comprising:
a plurality of light sources disposed in a left-right direction;
a light-source-side lens disposed in front of the light sources and emitting light forward; and
a projection lens disposed in front of the light-source-side lens and emitting, in front of a vehicle, the light emitted from the light-source-side lens, wherein
the light-source-side lens includes an incident surface through which light from the light sources enters,
the incident surface includes at least one groove portion disposed at a position offset from an optical axis of the projection lens in the left-right direction and extending in an up-down direction, and
the groove portion includes an inclined portion that refracts the light from the light sources toward a side closer to the optical axis.

2. The vehicle headlight according to claim 1, wherein
when viewed in an optical-axis direction along the optical axis, the groove portion is disposed such that at least a part of a portion of the incident surface facing a corresponding light source is left.

3. The vehicle headlight according to claim 2, wherein
when viewed in the optical-axis direction along the optical axis, the groove portion is disposed such that the inclined portion is located between the light sources that are adjacent in the left-right direction.

4. The vehicle headlight according to claim 2, wherein
a plurality of the groove portions is spaced apart in the left-right direction.

5. The vehicle headlight according to claim 4, wherein
the groove portions are disposed on a left side and a right side of the optical axis.

6. The vehicle headlight according to claim 4, wherein
the groove portions are disposed closer to an outside of the vehicle in the left-right direction with respect to the optical axis.

7. The vehicle headlight according to claim 5, wherein
a number of groove portions disposed on the left side of the optical axis is different from a number of groove portions disposed on the right side of the optical axis.

8. The vehicle headlight according to claim 1, wherein
the light-source-side lens has an exit surface through which the light incident on the incident surface exits, and
the exit surface includes a central portion through which the optical axis passes, and curved portions that curve to a rear side from the central portion to both ends in the left-right direction of the exit surface.

9. The vehicle headlight according to claim 8, wherein
the groove portion is disposed in a portion overlapping the curved portion when viewed in an optical-axis direction along the optical axis.
